(19) United States
(12) Patent Application Publication
(10) Pub. No.: US 2006/0256133 A1
(43) Pub. Date: Nov. 16, 2006

(54) GAZE-RESPONSIVE VIDEO ADVERTISMENT DISPLAY

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/465,777

(22) Filed: Aug. 18, 2006

Related U.S. Application Data
(60) Provisional application No. 60/740,329, filed on Nov. 28, 2005.
(60) Provisional application No. 60/733,416, filed on Nov. 5, 2005.

(51) Int. Cl. G09G 5/00

(52) U.S. Cl. 345/619

(57) ABSTRACT

A system for gaze-responsive video advertising is provided that includes a video display for playing advertisements to a user, a gaze-tracking element, and a processor. The processor (a) determines whether the user's gaze falls within a predetermined spatial boundary of an advertisement display area, (b) plays a video-based advertisement within the predetermined spatial boundary in response to the determining, (c) stops play of the video-based advertisement in response to determining that the user's gaze falls outside of the predetermined spatial boundary for an amount of time exceeding a predetermined time threshold, and (d) resumes play of the video-based advertisement after the stopping in response to determining that the user's gaze falls within the predetermined spatial boundary of the advertisement display area. In some embodiments, exposure credits are awarded to the user for confirmed duration increments of video watching.

### RELATED APPLICATION DATA

This application claims priority to provisional application Ser. No. 60/740,329, filed Nov. 28, 2005, the disclosure of which is hereby incorporated by reference as if fully set forth. This application is related to provisional application Ser. No. 60/733,416, filed Nov. 5, 2005; application Ser. No. 11/381,504 filed May 3, 2006; and application Ser. No. 11/278,369 filed Mar. 31, 2006, the disclosures of which are hereby incorporated by reference as if fully set forth.

### FIELD OF THE APPLICATION

The present application is directed generally toward a display for showing electronic video advertisements, and more specifically toward a display for monitoring whether video advertisements are being viewed based on user's gaze.

### BACKGROUND

In traditional media-content distribution models, content is provided to users free of charge in exchange for advertisements being embedded into the content stream. Traditional television content is distributed using this model, providing free video content to users in exchange for advertisements being embedded in the content stream as periodic commercials. Web page content is also distributed using this model, web content and services being provided free to users in exchange for advertisements being embedded into the displayed web page that provides the content or services. The benefit of such traditional media distribution models is that sponsors pay for the distribution of content to users, giving users free access to desirable content. Sponsors do this because the users are being exposed to the sponsors advertising messages as they view the content.

A significant problem with the traditional media-content distribution model is that the sponsors have no guarantee that the user is actually exposed to the advertising message that has paid for the accessed content or services. For example, in traditional television programming a viewer may change the channel, leave the room, mute the television, engage in a side conversation, or simply not pay attention when a paid commercial is being displayed. With the advent of recordable mediums for television, like TiVo for example, the viewer may be watching a recording of broadcast content and may simply fast-forward past some or all of the advertisements. With the advent of more intelligent recordable mediums for television, the user may even use a smart processing system that automatically forwards past some or all of the advertisements. Similar problems exist for radio. In traditional radio programming a viewer may change the channel, leave the room, mute the radio, engage in a side conversation, or simply not pay attention when a paid commercial is being displayed by the radio player. With the advent of recordable mediums for radio, including but not limited to downloadable podcasts of radio content, the viewer may be listening a recording of the content and may simply fast-forward past some or all of the advertisements. With the advent of more intelligent recordable mediums for radio broadcasts, the user may even use a smart processing system that automatically forwards past some or all of the advertisements. Similar problems exist for web-based advertisements. In traditional web advertising methods, a user is exposed to displayed advertisements on the same web page on which the desired content or services is being displayed. The user may simply ignore such simultaneously displayed advertisements, may not have their window open all the way to even display the advertisements, or may filter out advertisements intelligent web page processing methods. Consequently, sponsors who pay for video programming such as television, audio programming such as radio, and web based content and services, often have little assurance that users are actually being exposed to the message they are providing in exchange for paying for the content.

Another problem with traditional media content distribution models is that media is now being distributed in new ways. With content-on-demand services and pointcast systems, content is no longer presented in a linear manner such that paid advertisements can be easily intermingled within the content stream. Some systems have been developed that do just that, but they suffer from all the traditional problems described above. The most common solution to the problem for content-on-demand services is to avoid paid advertisements all together and shift to a pay-per-view model for users. A better solution is therefore needed that retains the benefits of paid advertising but better meshes with the non-linear nature of content-on-demand and pointcast technologies.

To solve this problem, numerous systems have been developed. One system is disclosed in US Patent Application Publication No. 2005/0028190, entitled “Management of Television Advertising,” which is hereby incorporated by reference. This system requires the user to press an input button as part of the advertising viewing process. This is intended to ensure that the user is present as the advertisement plays, but does nothing to ensure that the user is actually paying attention after he or she has pressed the button. Furthermore, the user may be engaged in a side conversation or may be reading a book or doing some other distracting activity that reduces or eliminates the user's actual exposure to the information. Such systems have limited value and there is substantial need for additional solutions to this problem.

Another system tracks a user's viewing location (i.e., gaze location) as he or she explores content on a web page and awards rewards to the user if and when his or her gaze corresponds with the location of certain advertisements. This method, as disclosed in US Patent Application Publication No. 2005/0108092, entitled “A Method of Rewarding the Viewing of Advertisements Based on Eye-Gaze Patterns,” which is hereby incorporated by reference, is aimed at text based advertisements but does not address the unique needs of video stream based advertisements that are played to a user over a period of time. Video is substantially different than text in that it plays for a prescribed time period and therefore delivers content at a particular predefined rate. If a user is not present during the prescribed time period and/or is not watching the screen, messaging is streamed but not received. Thus the prior art systems do nothing to guarantee that a user pays attention to a playing video advertisement over a period of time not does it reward a user for watching the full duration of a streaming video advertisement and/or for watching a certain percentage of the duration of a streaming video advertisement. It also does not address the fact that a streaming video advertisement may continue to play during period of time that a user looks away, leaves the room, or otherwise disengages viewing of the content. Thus there is substantial need for new solutions to this problem.

Other systems have been developed to address the advertising needs of on-demand-programming and pointcast systems. One such system is disclosed in US Patent Application Publication No. 2001/0041053, entitled “Content-On Demand Advertisement System,” which is hereby incorporated by reference. The system provides credit to a user for viewing an advertisement, such as a commercial, the credit being usable to purchase on-demand-programming. Such a system does not provide a convenient, natural, or quantifiable means to determine if the user was exposed to the informational content of a video advertisement that plays over a period of time and does not halt the playing of the informational content if a user looks away from the screen. Thus many of the same problems described above for traditional media-content distribution holds true for such on-demand-programming media content distribution models. There is therefore a need for new and innovative methods to ensure that a user is exposed to streaming video advertisements. There is also a need for new and innovative methods that reward users for viewing the full duration and/or a percentage of the duration of a video stream advertisement.

### SUMMARY

The present invention is directed to a method, apparatus, and computer program for displaying video based advertisements with dependence upon a user's gaze. More specifically the present invention specifies a method, apparatus, a computer program for playing a video based advertisement at moments in time when it is determined that the user's gaze falls within the spatial limits of the advertisement display area (or some other similarly defined spatial area) and for not playing and/or ceasing the play of a video based advertisement at moments in time when it has been determined that the user's gaze falls outside of the spatial limits of an advertisement display area (or some other similarly defined spatial area) for more than some threshold amount of time.

In some embodiments a still title screen and/or a short repeating video segment portion of the advertisement is made to play upon the screen of an advertising display device. The user's gaze location is monitored by hardware and software components of the present invention. The control software of the present invention is configured not to play the body of video stream advertisement until it is determined that the user's gaze falls within the spatial limits of the advertisement display area (or some other similarly defined spatial area). Thus the still title screen and/or short repeating title video segment continues to play for a portion of time until it is determined that the user is looking substantially at the advertisement display area. Upon determining that the user's gaze falls within the defined spatial area, the body of the video stream advertisement is made to play by software routines. Software controlled play of a video segment may be performed using standard video display methods known to the art. For example the video segment may be stored as a standard digital file, such as an MPEG file, which is read from memory, decoded, and displayed upon a particular screen area of a target display screen at a prescribed rate. In general audio content is also accessed from memory and displayed through speakers, headphones, or other audio display hardware at a prescribed rate. In this way the control software of the present invention enables the play of the body of the advertisement while it is determined that a user's gaze falls within the defined spatial area portion of the display screen, the defined spatial area corresponding with the display of the advertisement such that if the user's gaze falls within the defined spatial area, he or she is looking substantially in the direction of the advertisement. The user's gaze is monitored regularly using gaze-tracking hardware and software during the playing of the video advertisement. If it is determined that the user's gaze has left the defined spatial area for more than some threshold amount of time, the playing of the video stream advertisement is halted. This is generally performed by causing a pause in the video play, freezing the current image frame upon the screen. The threshold amount of time is generally set in hardware or software such that the user must look away for a long enough amount of time that a momentary glance away will not cause the display of the video advertisement to pause. This is because even while paying attention to a video stream, users may glance away momentarily while maintaining concentration on the video stream. The user may glance away, for example, to grab a cup of coffee, to see a person entering or exiting the room, to sneeze, or to take some other brief and common action. Thus an innovative aspect of the present invention is the use of a time threshold such that the video stream is not paused unless it is determined by the hardware and software of the present invention that the user has looked away from the defined spatial area for more than that threshold amount of time. In some embodiments of the present invention, the threshold amount of time is set to 6 seconds. This threshold is referred to herein as a look-away threshold.

Upon determining, by use the gaze tracking hardware and software of the present invention, that a user has looked away from the defined spatial area for more than the threshold amount of time, the video stream is paused by the control software of the present invention until it is determined that the user's gaze has returned to the defined spatial area. In some embodiments a second time threshold value is used such that the user must return his or her gaze to the defined spatial area for more than this second time threshold amount of time for the video stream to resume playing. This prevents the video to resume playing in response to a fleeting glance from the user. In general this second amount of time is selected long enough such that it will not trigger play upon a fleeting glance, but short enough that a user does not feel like time is being wasted while he or she waits for the video to resume playing.

In some embodiments this second threshold amount of time is set to 2 seconds. This threshold is referred to herein as a resume threshold.

In some embodiments of the present invention, the video stream that resumes playing upon a returned glance is not the same moment in time in the video stream at which it was halted. This is because the user has generally looked away some number of seconds before the video stream was halted by the control software. For example in common embodiments the user must look away for 6 seconds before the video was halted, thus the user missed 6 seconds of video content prior to the software automatically pausing the video play.

Because a paid advertisement may be short, for example only 30 seconds, missing 6 seconds may be significant. Thus the software of the present invention may be configured such that the video stream, upon resume of play after a look-away, starts from a moment in time in the video stream that is prior to the moment in time when it was halted. This is generally referred to as rewinding the video stream by some amount of time. Thus the software of the present invention may be configured to rewind the video stream by some amount of time, generally an amount equal to or shortly longer than the look-away threshold. In some embodiments the software is configured to rewind the video stream upon a resumed gaze by an amount equal to the look away threshold. This causes the video to resume playing from the last moment in time viewed by the user. In other embodiments the software is configured to add a short amount of time to the look away threshold such that additional viewing context is provided to the user so that he or she gets the full impact of the missed material. For example, in some embodiments two seconds may be added to the look away threshold. This added amount of time is referred to herein as the Added Rewind Time. Thus upon a returned gaze the video is rewinded by an amount equal to the look away threshold plus the added rewind time. The video then resumes playing from that previous point in time.

In some embodiments of the present invention the look away threshold may be determined by the software of the present invention based in whole or in part upon the duration of the advertisement. For example, the software of the present invention may be configured to select and/or derive a shorter look away threshold time for a short duration advertisement than it selects and/or derives for a longer duration advertisement. For example, the software of the present invention may set the look away threshold to be 5 seconds for a video advertisement that is 30 seconds in total duration, but may set the look away threshold to 12 seconds for a video advertisement that is 15 minutes in duration.

In some embodiments of the present invention if the user looks away from the display area during the display of a particular advertisement for more than some maximum look-away threshold amount of time, the software may be configured to rewind the advertisement all the way to the beginning. This is because it may be determined by the software that the interruption was so long, a user could not resume viewing and maintain the mental context for continued viewing in a way that will successfully deliver the advertising message. For example, a maximum look away threshold may be set in some embodiments to 30 minutes. Thus if a user ceases viewing a particular video advertisement (i.e., his or her gaze leaves the defined spatial area) and returns to view that advertisement after 30 minutes of time has elapsed, the control software of the present invention may be configured to rewind the video advertisement to the beginning upon resume of play.

The present invention is also a method, apparatus, and computer program for awarding credits to a user in response to a user successfully viewing the complete duration of a video stream advertisement. Because the current invention is operative to ensure that a user must substantially view the full duration of a video advertisement in order for it to be displayed in full duration to a user, the software can easily be configured to award credits to a user upon the completed display of the full duration of a video based advertisement. As used herein, these credits are referred to as Exposure Units for they represent a value earned by the user in return for being exposed to a certain advertising message.

In some embodiments of the present invention a particular number of Exposure Units to be awarded for a user for viewing a particular video advertisement are determined in partial dependence upon the number of times a user looked away from the defined display area during the viewing of the complete advertisement. This is because a user who looks away many times during the viewing may be considered to have not paid as close attention to a user who looks away fewer times during the viewed advertisement. In some embodiments a running tally of accrued time that a user spent looking away from the defined display area is computed by the software of the present invention and used in part to determine the number of Exposure Units to be awarded to the user for viewing the particular video advertisement. The number of times that a user looks away from an advertisement during the viewing duration is referred to herein as the Look-Away Count. The accrued amount of time that a user spent looking away from an advertisement during the viewing duration is referred to herein as the Look-Away Time Talley. Thus, embodiments of the present invention may be configured to use the Look-Away Count and/or the Look-Away Time Talley when computing the number of Exposure Units awarded to a user for viewing a particular advertisement.

In some embodiments of the present invention a user may be awarded Exposure Units for viewing a particular advertisement even if the user chooses not to view the full duration of the advertisement. In such embodiments the number of Exposure Units awarded to the user may be computed by the software of the present invention in partial dependence upon the amount or percentage of the advertisement's full duration that was successfully viewed by the user.

In general, exposure units that are awarded to a user are added by the software of the present invention to an exposure account. The exposure account indicates the number of exposure units earned by the user over a period of time. The exposure units stored in the exposure account are redeemable by the viewer for a certain amount of viewable programming and/or a certain amount of a provided service. For example, the viewer may be awarded a certain number of exposure units for viewing a certain video advertisement in its entirety. The certain number of exposure units are added to the viewers exposure account. The viewer may then use the exposure units to purchase viewable content such as television programming, movies, music, or other published content. In this way the user is gaining access to desirable content in exchange for being exposed to promotional content through a means that allows the promotional content to be experienced independently of the desirable content. Such a system is therefore ideal for content-on-demand delivery systems.

In some embodiments of the present invention the user is shown a running tally of exposure units earned. In some such embodiments the running tally is displayed as a numerical value in a corner (or other unobtrusive area) of the screen upon which the video advertisements are displayed. In some embodiments the running tally is displayed as a graphical chart or table. Regardless of how the running tally is presented to the user, the use of a displayed running tally is a valuable feature. In this way the user has direct feedback of how his viewing of certain durations of the advertisement translates into exposure units earned.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates an exemplary system configuration according to at least one embodiment of the present invention;

FIG. 2 illustrates an example screen as might be viewed by a user who is interacting with computer 1 according to at least one embodiment of the invention;

FIG. 3 illustrates a defined spatial area for a video advertisement according to at least one embodiment of the invention;

FIG. 4 depicts an electronic book according to at least one embodiment of the invention;

FIG. 5 illustrates a flow chart showing a sample embodiment of control software flow according to at least one embodiment of the invention;

FIG. 6 illustrates a defined spatial area for a video advertisement according to at least one embodiment of the invention; and

FIG. 7 illustrates a computer according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention are directed to a method, apparatus, and a software program for displaying video based advertisements with dependence upon the presence or absence of a user's gaze within a defined spatial area, the defined spatial area at least partially corresponding to the display location of the video advertisement. More specifically, the present invention is directed to a method, apparatus, a computer program for playing a video based advertisement at moments in time when it is determined that the user's gaze falls within the spatial limits of a defined spatial area, the defined spatial area at least partially corresponding with the screen area on which the video based advertisement is displayed and for not playing and/or ceasing the play of a video based advertisement at moments in time when it has been determined that the user's gaze falls outside of the spatial limits of the defined spatial area for more than some threshold amount of time.

A variety of technologies exist for tracking the location at which a user is looking when visually attending to items displayed upon display screen. As used herein a display screen may be the screen of a computer, a television, or other electronic device, including but not limited to desktop devices, living room devices, and/or handheld devices. A display screen may also be a surface upon which an image is projected. Thus, for the purposes of the embodiments described below, a display screen is any area upon which a video-based advertisement is displayed, projected, or otherwise presented. Thus, embodiments of the present invention provide a display screen and a technology for tracking the location upon the display screen at which a user is looking at various moments in time. Often referred to as gaze-tracking or eye-tracking technology, such tracking systems generally work by sensing the direction that user is looking and thereby determining where upon a display screen the user's gaze is falling at particular points in time. The systems are generally accurate and fast, allowing the location of the user's gaze to be tracked in real time as he or she scans an electronic display. For example, some gaze-tracking systems on the commercial market today can enable a user to control a cursor on a computer screen based upon where on the screen he or she is looking at various points in time. Similarly, the gaze-tracking systems of the present art can be used to determine in real-time, with minimal time delay and reasonable accuracy, whether or not a user's gaze is or is not aimed within a particular defined spatial area upon the display screen. It is such a feature of gaze tracking systems that is employed by the unique and powerful video-based advertisement display system disclosed herein.

A variety of gaze tracking systems are known to the current art. For example, an eye tracking device has been developed by the IBM Corporation at its Almaden Research Center and is referred to by the acronym “MAGIC.” This device is mounted proximate to a display screen, in a known positional relationship. When a user is viewing the screen, the IBM eye tracking device determines the point of gaze or focus, with respect to the screen, of the pupils of the user's eyes. Such device generally comprises a camera which acquires successive image frames at a specified rate, such as 30 frames per second. The device further comprises two near infrared time multiplexed light sources, each composed of a set of IR light emitting diodes (LED's) synchronized with the camera frame rate. The system tracks eye focus by detecting the reflection of the emitted light off the user's eyes. More specifically, one light source is placed on or very close to the optical axis of the camera, and is synchronized with even frames. The second light source is positioned off of the camera axis, and is synchronized with the odd frames. The two light sources are calibrated to provide approximately equivalent whole-scene illumination. When the on-axis light source is operated to illuminate a reader's eye, which has a pupil and a cornea, the camera is able to detect the light reflected from the interior of the eye, and the acquired image of the pupil appears bright. On the other hand, illumination from off-axis light source generates a dark pupil image. Pupil detection is achieved by subtracting the dark pupil image from the bright pupil image. After thresholding the difference, the largest comnected component is identified as the pupil.

Once the pupil has been detected, the location of the corneal reflection (the glint or point of light reflected from the surface of the cornea due to one of the light sources) is determined from the dark pupil image. A geometric computation is then performed, using such information together with a known positional relationship between the gaze-tracking sensor system and the electronic display. The computation provides an estimate of a reader's point of gaze in terms of coordinates on the electronic display.

The eye tracker device disclosed above is described in further detail in a paper entitled Manual and Gaze Input Cascaded (Magic), S. Zhai, C. Morimoto and S. Ihde, In Proc. CHI '99: ACM Conference on Human Factors in Computing Systems, pages 246-253. Pittsburgh, 1999. It should be appreciated, however, that the embodiments described below are not limited to the gaze-tracking sensor system described in the paper referenced above. Instead, it is anticipated that a wide variety of gaze-tracking sensor systems will readily occur to those of skill in the art for use in enabling the present invention. For example, gaze-tracking systems such as the ones disclosed in published U.S. patent applications 2003/0038754, entitled “Method and apparatus for gaze responsive text presentation in RSVP display,” 2002/0180799, entitled “Eye gaze control of dynamic information presentation,” 2004/0075645, entitled “Gaze tracking system,” and 2005/0175218, entitled “Method and apparatus for calibration-free eye tracking using multiple glints or surface reflections,” may be used alone or in combination to enable the present invention. Finally it should be noted that the technical requirements for gaze-tracking for embodiments of the present invention are significantly lower than many text-based applications because there is not the need to as accurately resolve where upon the screen the user is looking. Instead, embodiments of the present invention only need to determine if the user is looking within the defined spatial area or not, an area that is generally much larger than many of the items that gaze tracking systems of the current art can currently resolve (such as icons, buttons, words, and letters). This may allow for less expensive and/or less computationally intensive gaze tracking requirements for the present invention as compared to other common applications of gaze-tracking hardware and software.

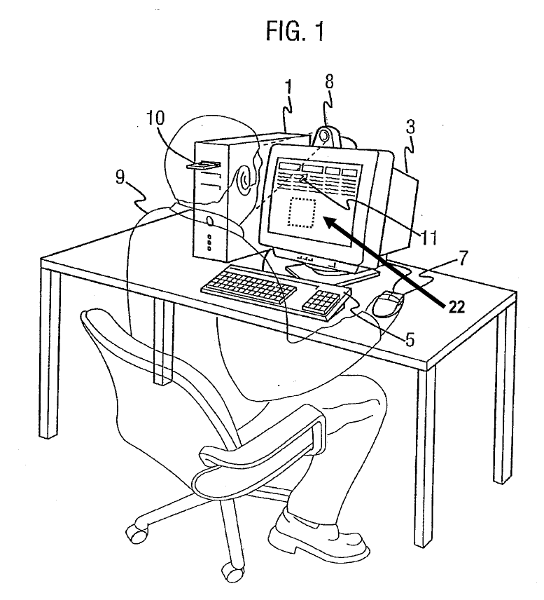

FIG. 1 illustrates an exemplary system configuration according to at least one embodiment of the present invention. As shown, a user 9 is sitting in front of an electronic display 3 which in this case is a computer monitor sitting upon a desk. The electronic display 3 in this example is a desktop system, but those skilled in the art would appreciate that other electronic displays such as the displays associated with handheld devices including but not limited to e-books, PDAs, cell phone, wrist watches, portable media players, and portable gaming systems could alternatively be employed. Similarly, projectors, head mounted displays, and other non-screen based displays may be used in some systems of the present invention.

As shown in FIG. 1, the electronic display 9 is driven by a personal computer 1 to display various images and documents upon the screen. At the instant shown, screen 11 represents a computer generated display that a user may manipulate and/or navigate using a cursor that is also displayed. For example, the user might be navigating the internet using the cursor, searching for certain desired information. In this example embodiment the cursor is controlled by mouse interface 7 that is connected to personal computer 1 and manipulated by user 9. The user may also manipulate and/or navigate the displayed document using keyboard 5 that is also connected to the personal computer. Using the keyboard and mouse, the user may, for example, scroll through the document, switch between documents, switch between applications, open and close files, and/or otherwise control which documents, images, videos, web pages, and/or other content that is displayed upon the screen at any given time.

Also shown in FIG. 1 is a gaze-tracking system 8 that tracks the location of the user's gaze as he or she looks upon screen 11. The gaze-tracking system 8 may take many forms and is not restricted to a particular technology. As shown in FIG. 1, gaze tracking system 8 includes a camera mounted in a location such that it can capture an image of the user's eyes as he or she gazes upon screen 11. The gaze-tracking system 8 may also include one or more light sources that reflect light off portions of the user's eyes to assist in rapidly tracking the location of the user's eyes. The gaze-tracking system 8 includes software running upon computer 1 or may include gaze processing software running upon an embedded processor specific to the gaze tracking system itself. Regardless of where the gaze processing software resides, it is operative to process the sensor signals detected by gaze-tracking system and produce coordinates and/or other indicia representing the location at which the user is looking upon the screen at various points in time. The gaze-tracking software may be stored on a CD-ROM 10 or other memory storage device inserted into the computer 1. In one common embodiment the gaze-tracking system 8 and associated software produces screen coordinates at which the user is looking at any given moment, the screen coordinates being rapidly updated at a rate such as 60 times per second. In some embodiments of the present invention the gaze processing software is integrated into and/or communicates with system software such that the software produces references to on-screen elements that the user is currently looking at, the on-screen elements including indications of which windows, documents, menus, buttons, icons, words, characters and/or other symbolic elements a user may be looking at.

Also shown in FIG. 1 is a defined spatial area 22 upon the screen 11. This defined spatial area may be at any location and of any shape upon the screen, although the shape is generally chosen to correspond with the approximate size and shape of the frames of a particular video advertisement that is to be displayed upon the screen at that location. In this example defined spatial area 22 is shown as a rectangular shape that defines a portion of screen area 11. In some embodiments the defined spatial area 22 may encompass the entire screen area 11. In some embodiments multiple defined spatial areas 22 may be individually defined upon a single screen area 11. The defined spatial area is an area upon the screen, usually defined as a set of screen coordinates that indicate the boundaries of the area, represented in memory and accessed by the software of the present invention. The software of the present invention is operative to determine if and when the user's gaze falls within the defined spatial area by comparing the data from the gaze tracking system with the boundaries of the defined spatial area.

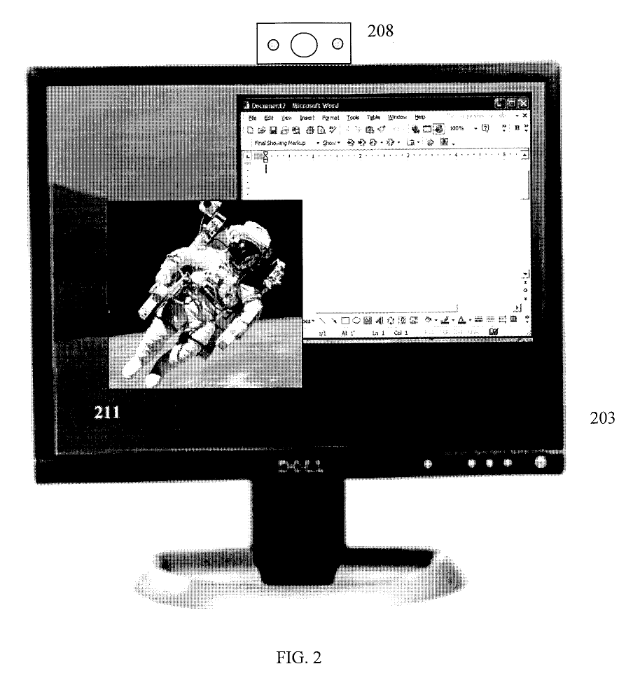

FIG. 2 illustrates an example screen as might be viewed by a user who is interacting with computer 1 according to at least one embodiment of the invention. The screen shown is a flat panel monitor 203 that is used equivalently with the traditional monitor shown in as element 3 in FIG. 1. Affixed to the flat panel monitor is a gaze-tracking system 208 that operates equivalently to the gaze-tracking system 8 in FIG. 1. The particular gaze tracking system shown as 208 includes a camera and two light sources. Other embodiments of gaze tracking systems may be used as described previously. Also shown in FIG. 2 is a video advertisement 211 displayed upon the screen for the user to view. The video advertisement 211 might be displayed in a pop-up window that automatically comes up in response to a user requested service or content. The video advertisement 211 is shown filling a portion of the screen although in some examples the advertisement may be displayed filling the full screen.

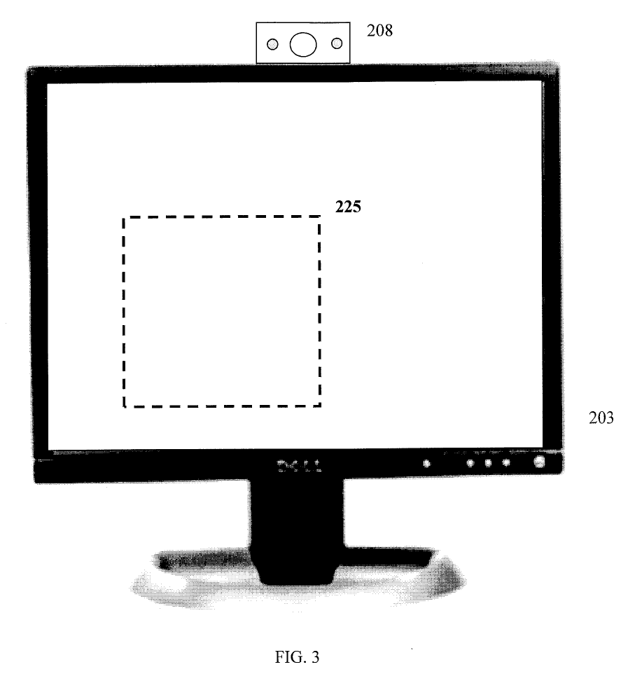

The screen location of the video advertisement 211 corresponds with the screen location of a defined spatial area 225. For the video advertisement 211 shown in FIG. 2, an example defined spatial area is shown in FIG. 3 as element 225. In this example the defined spatial area 225 corresponds with the exact same screen area within which the video advertisement 211 is displayed. In some embodiments the defined spatial area 225 may be slightly larger or smaller than the area of its corresponding video advertisement 211. The key is to define the defined spatial area 225 such that a user whose gaze falls within it will be looking substantially in the direction of the video advertisement with which it is associated. It many embodiments this generally means having a size and shape of the defined spatial area and video advertisement display area to be approximately the same.

In some embodiments a different size spatial area 225 may be used in software to determine at look-at event as is used to determine a look-away event. For example, a slightly smaller area 225 may be used to determine if a user is looking at the advertisement as compared to the area used to determine if the user is looking away from the advertisement. The use of such differing areas prevents the situation wherein a user may be looking upon or near the border of area 225 and inadvertently cause the video to start and stop repeatedly due to small errors in gaze sensor data readings. The use of a smaller size of area 225 to determine if a user is looking at the advertisement and a larger size area 225 to determine if a user is looking away from the advertisement is referred to herein employing a hysteresis band upon the boundary of spatial area 225.

As shown in FIG. 2 and FIG. 3, gaze tracking hardware 208 is operative to detect the location of the user's gaze upon the screen area of monitor 203 and/or detect if the user's gaze has the screen area of monitor 203 all together. In some embodiments gaze tracking hardware 208, in conjunction with gaze tracking software, reports data as to the location of the users gaze upon the screen area 203 and/or reports data indicative of whether or not the user's gaze has left the screen area all together. Thus as the user looks upon the screen of the current example, the eye tracking hardware and software of the present invention tracks the user's eyes and determines the location upon the screen the user is looking and/or determines if the user is not looking at the screen at all. The gaze-tracking hardware and software routines determines in real time (with minimal time delay) where the user is looking and reports data indicative of this screen location and/or reports data indicative that the user's gaze is no longer upon the display. In some embodiments this data is stored in a buffer or other memory structure. In some such embodiments a time history of gaze location is stored and made accessible by the routines of the present invention. The time history might be, for example, a representation of the last five seconds worth of gaze locations captured for the user.

The data buffering aside, the gaze-tracking hardware and software of the present invention are operative to determine in real time (with minimal time delay) the current location where the user is looking and/or determines if the user's gaze is outside a certain range (usually the bounds of the screen area itself). Thus as the user looks upon the screen during normal interaction with the displayed content, the gaze-tracking hardware and software routines determine the screen coordinates where the user is looking. If and when a video advertisement 211 is displayed and/or is preparing to be displayed, software routines compare the screen location where the user is looking to the boundaries and/or area of the defined screen area that corresponds with the particular video advertisement 211 to determine if the user is looking at the video advertisement 211. If yes, the video advertisement 211 is played. If not, the video advertisement 211 is paused subject to the various time threshold methods described herein. These methods are described in more detail later in this document.

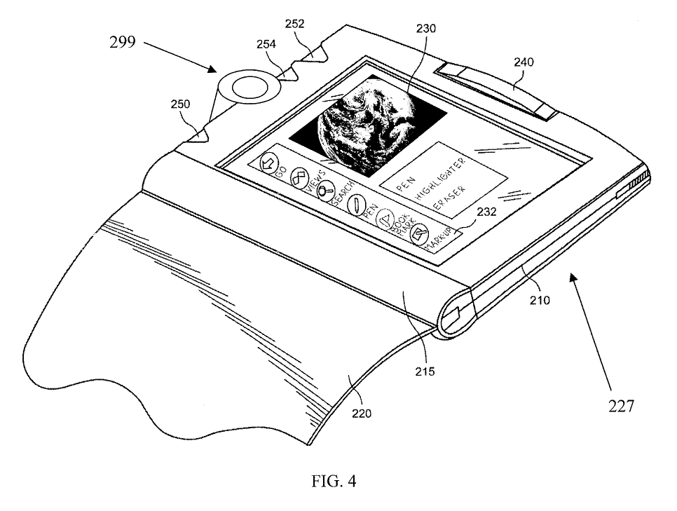

Although the description provided thus far refers to traditional screens such as computer monitors and flat panel displays, the present invention is applicable to a wide range of display technologies including screens, projected images, electronic paper, and other display technologies. Thus display screens as used herein is generally referring to any technology through which an image is displayed to a user such that a user looks upon a surface or area and reads text by moving his or her eyes across the textual display region. As an example alternate embodiment, FIG. 4 depicts an electronic book according to at least one embodiment of the invention. In such an embodiment the user views a video based advertisement 230 upon the screen of a portable computing device, the gaze tracking hardware 299 integrated into the casing of the portable computing device 210.

As disclosed in U.S. Pat. No. 6,493,734 which is hereby incorporated by reference, an electronic book is a device that receives and displays documents, publications, or other reading materials downloaded from an information network. An electronic book can also be a device that receives and displays documents, publication, and/or other reading materials accessed from a data storage device such as a CD, flash memory, or other permanent and/or temporary memory storage medium. In some embodiments the accessed materials are provided in exchange for user exposure to video based advertisements that are also displayed upon the electronic book. Embodiments of the present invention enable a user to view video based advertisements upon the electronic book and receive exposure units in return for watching at least a portion of the video based advertisements, and exchange the exposure units for materials downloaded onto the electronic book. In some embodiments as described herein a user must view the full duration of the video based advertisement in order to receive exposure units for that advertisement. In some embodiments of the present invention each advertisement is assigned a certain number of exposure units that are awarded in exchange for full viewing. In some such embodiments the number of exposure units are dependent upon and/or proportional to the full duration length of the video based advertisements. For example, a sixty second video based advertisement may be worth some number of video based units (for example 600 exposure units) while a five minute advertisement may be worth some larger number of exposure units (for example 3000 exposure units). In general a user may exchange exposure units for downloadable content and/or a service.

In a common embodiment, users of an electronic book can read downloaded contents of documents, publications, or reading materials subscribed from a participating bookstore at his or her own convenience without the need to purchase printed version. In such embodiments the transaction may be entirely based upon exposure units—a user may earn exposure units by viewing advertisements using the methods and apparatus disclosed herein and may use the exposure units to purchase the downloadable content.

As discussed above, FIG. 4 illustrates an electronic book 227 in accordance with one embodiment of the invention. The electronic book 227 includes a housing 210, a battery holder 215, a cover 220, a display screen, a page turning interface device 240, a menu key 250, a bookshelf key 252, and a functional key 254. The housing 210 provides overall housing structure for the electronic book. This includes the housing for the electronic subsystems, circuits, and components of the overall system. The electronic book is intended for portable use; therefore, the power supply is mainly from batteries. The battery holder 215 is attached to the housing 210 at the spine of the electronic book 227. Other power sources such as AC power can also be derived from interface circuits located in the battery holder 215. The cover 220 is used to protect the viewing area. Also included in the housing is the gaze tracking hardware 299. In many embodiments the gaze tracking hardware 299 includes one or more cameras or other optical imaging components. In many embodiments the gaze tracking hardware also includes one or more light sources for reflecting light off the eyes of the user.

The display screen provides a viewing area for the user to view the electronic reading materials retrieved from the storage devices or downloaded from the communication network. The display screen may be sufficiently lit so that the user can read without the aid of other light sources. The display screen may also display video based advertisements under control routines consistent with the present invention. As described previously, the control routines of the present invention are operative to display video based advertisements with dependence upon a user's gaze. More specifically the present invention is a method, apparatus, a computer program for playing a video based advertisement at moments in time when it is determined that the user's gaze falls within a defined spatial area upon the display screen, the defined spatial area corresponding at least in part with the area of the screen upon which the video based advertisement is displayed. The control of the playing of the video based advertisements with dependent upon the location of the user's gaze is performed by control software running upon the processor of the present invention. The control software and resulting methods are described below in more detail.

As described herein, the present invention specifies a method, apparatus, and a computer program for displaying video based advertisements with dependence upon a user's gaze. More specifically the present invention is directed to a method, apparatus, a computer program for playing a video based advertisement at moments in time when it is determined that the user's gaze falls within or approximately within a defined spatial area that is relationally associated with the video based advertisement and for not playing and/or ceasing the play of a video based advertisement at moments in time when it has been determined that the user's gaze falls outside a defined spatial area that is relationally associated with the video based advertisement for more than some threshold amount of time. In many such embodiments the defined spatial area is a screen area that corresponds and/or approximately corresponds with the screen area upon which the video based advertisement is displayed.

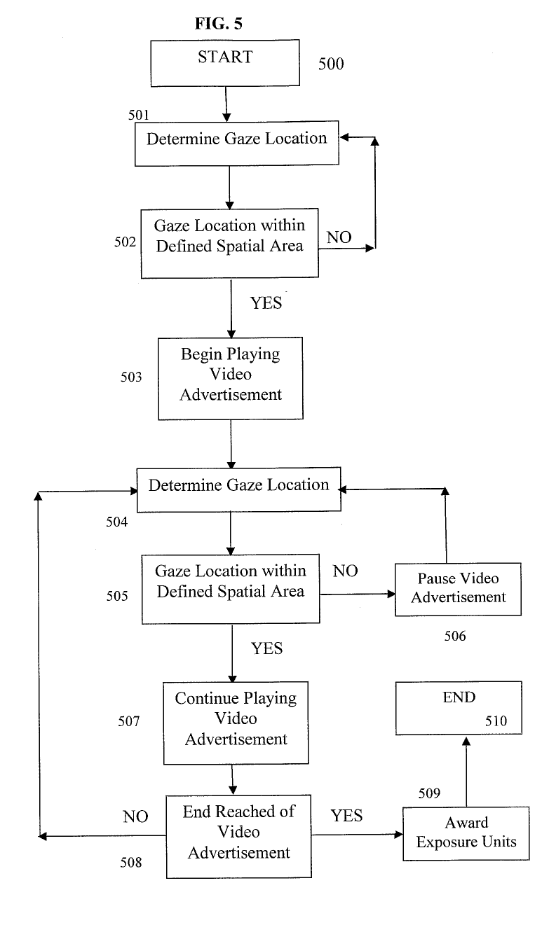

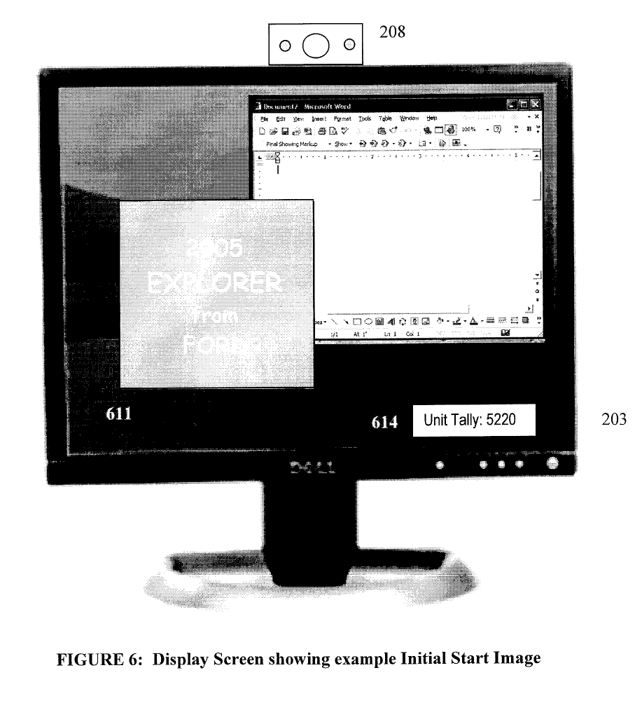

FIG. 5 illustrates a flow chart showing a sample embodiment of control software flow according to at least one embodiment of the invention. The process starts when it is determined by another process that a video based advertisement is ready to be displayed to the user. This advertisement might be triggered, for example, by the user requesting a certain service or piece of content for access upon a computer network. The process starts at step 500 after a video based advertisement has been selected and is ready to play. In some embodiments, an initial start image is displayed in the area at which the advertisement will play so as to attract the user's visual attention to the display area prior to the advertisement beginning the play. This initial start image may be, for example, a still image that includes a title screen. It might be, for example, a rectangular image of a solid color. It might also be a short repeating video segment portion of the advertisement is made to play upon the screen of an advertising display device. The key to the initial start image, whether it is a still image or a repeating video image, is that it (a) attracts the users visual attention to the area (or approximate area) at which the video advertisement will play and (b) informs the user that a video is ready to play at that location. An example initial start image is shown in FIG. 6 as element 611. In this case the initial start image is a still image displaying text indicating that an advertisement is ready to play for the 2005 model year Explorer car from Ford motor company. The still image also indicates the size and shape of the display area within which the video advertisement will play.

Thus at step 500 the initial start image associated with the selected video advertisement is displayed upon the screen at a particular location. At the same time a defined spatial area is defined in memory of the computer processor running the software of the present invention, the defined spatial area defined to correspond or approximately correspond with the area upon which the video advertisement will display. This spatial area might be, for example, defined as the dotted line showed in FIG. 3 as element 225.

Once the initial start image is displayed and the defined spatial area is selected and/or defined, the software process proceeds to step 501. At step 501 user's gaze location is monitored by hardware and software components of the present invention. This is generally performed by sensor data being read from the hardware components of the gaze tracking system, the sensor data being processed by the software components of the gaze tracking system such that a gaze coordinate is determined. Once a gaze location has been determined, generally as a gaze coordinate, the software process proceeds to step 502.

At step 502, the control software of the present invention determines whether or not the gaze location, as generally represented by a gaze coordinate, falls within the defined spatial area or not. In some embodiments this assessment involves not just a spatial comparison but also a consideration of one or more time thresholds. This conditional assessment can have two results—yes or no. If the result is “yes” (i.e., it is determined that the users gaze location falls within the defined spatial area for more than some threshold amount of time), the software branches to step 503 as shown in FIG. 5. If the result is no (i.e., it is determined that the user's gaze falls outside the defined spatial area), the software loops back to branch 501 as shown in FIG. 5. Thus if the user's gaze is outside of the define spatial area, the software just loops with the initial start image remaining upon the display. If, on the other hand, the user's gaze is detected to be within the defined spatial area for more than some threshold amount of time, the software branches to step 503 wherein the video starts playing. In this way the software displays the initial start image and loops, checking the user's gaze location, until it is determined that the user has looked at the location of the initial start image for more than some threshold amount of time. If so, the software starts playing the video based advertisement. The threshold amount of time is set, in some example embodiments, to 3 seconds. This particular threshold amount of time is referred to herein as the Start Image Gaze Threshold. It is generally set to a time that is long enough such that a fleeting glance by the user will not start the video playing. It is generally set to a time that is short enough such that the user does not need to wait very long when deliberately looking at the start image in order for the video to start playing. A value of 2 to 4 seconds is generally a good choice for the Start Image Gaze Threshold.

Once the user looks at the defined spatial area (i.e., the area of or approximately of where the start image is displayed) for more than the Start Image Gaze Threshold amount of time, the software proceeds to step 503 as described above. At step 503 the video based advertisement begins to play. In this way the video based advertisement beings to play in response to the user's gaze. The software then proceeds to step 504 wherein the user's gaze location is again determined using the hardware and software components of the gaze tracking system. The software then proceeds to step 505 wherein the control software of the present invention determines whether or not the gaze location, as generally represented by a set of gaze coordinate, still falls within the defined spatial area or not. In many common embodiments this assessment involves not just a spatial comparison but also a consideration of one or more time thresholds. This conditional assessment can have two results—yes or no. If the result at 502 is yes (i.e., it is determined that the users gaze location still falls within the defined spatial area), the software proceeds to step 507 wherein the video continues to play. This is generally performed by some number of additional frames of video being read from memory and played to the user upon the screen of the display. In addition a corresponding segment of audio is displayed to the user. The software then proceeds to step 508 wherein it is determined through a conditional assessment whether or not the video has reached the end of its full duration. If not, the software loops back to step 504 wherein the gaze location is determined again. If yes, the software branches to 509 wherein exposure units may be awarded to the user for viewing the full duration of the video based advertisement. The software routine then ends at 510.

Going back to step 505, if it had previously been determined that the result was “no,” (i.e., it was determined that the user's gaze had left the defined spatial area for more than some threshold amount of time), the software branches to 506 wherein the video segment is paused upon the screen. This is generally performed by a current frame being kept upon the screen. The software than branches back to 504. Thus if the user's gaze is determined to be outside of the define spatial area for more than a threshold amount of time, the software automatically pauses the display of the video and then continues to loop for as long as the user's gaze remains outside the defined spatial area. The threshold amount of time used in step 505 is referred to herein as the look-away threshold. In some preferred embodiments it is set to 6 seconds. In other embodiments it may be set to a different time or not used at all.

With respect to step 509 in which exposure units are awarded to the user, some embodiments of the present invention may take additional or alternate actions by which a user is rewarded, compensated, and/or is provided a product, service, or other form of imbursement for viewing the full duration of a video based advertisement. For example instead of receiving exposure units in step 509, the software of the present invention may be operative to unlock and/or provide user access to a piece of content. In another embodiment, instead of receiving exposure units in step 509, the software of the present invention may be operative to unlock and/or provide user access to a service. In some embodiments a user must view a plurality of video based advertisements to unlock a piece of content and/or gain access to a service.

Thus by following the steps of example embodiment software flow of FIG. 5, the control software according to an embodiment of the present invention is configured not to play the body of video stream advertisement until it is determined that the user's gaze falls within the spatial limits of the advertisement display area (i.e. the defined spatial area). Thus the still title screen and/or short repeating title video segment continues to play for a portion of time until it is determined that the user is looking substantially at the advertisement display area. Upon determining that the user's gaze falls within the defined spatial area, the body of the video stream advertisement is made to play by the software routines of the present invention. Software controlled play of a video segment may be performed using standard video display methods known to the art. For example the video segment may be stored as a standard digital file, such as an MPEG file, which is read from memory, decoded, and displayed upon a particular screen area of a target display screen at a prescribed rate. In general audio content is also accessed from memory and displayed through speakers, headphones, or other audio display hardware at a prescribed rate. In this way the control software of the present invention enables the play of the body of the advertisement while it is determined that a user's gaze falls within the defined spatial area portion of the display screen for more than a start image gaze threshold of time. The user's gaze is then monitored regularly using gaze-tracking hardware and software during the playing of the video advertisement. If it is determined that the user's gaze has left the defined spatial area for more than some threshold amount of time, the playing of the video stream advertisement is halted. This is generally performed by causing a pause in the video play, freezing the current image frame upon the screen. The threshold amount of time is generally set in hardware or software such that the user must look away for a long enough amount of time that a momentary glance away will not cause the display of the video advertisement to pause. This is because even while paying attention to a video stream, users may glance away momentarily while maintaining concentration on the video stream. The user may glance away, for example, to grab a cup of coffee, to see a person entering or exiting the room, to sneeze, or to take some other brief and common action. Thus, a key aspect is the use of a time threshold such that the video stream is not paused unless it is determined by the hardware and software of the present invention that the user has looked away from the defined spatial area for more than that threshold amount of time. In some embodiments of the present invention, the threshold amount of time is set to 6 seconds. This threshold is referred to herein as a look-away threshold.

Upon determining using the gaze tracking hardware and software of the present invention that a user has looked away from the defined spatial area for more than the threshold amount of time, the video stream is paused by the control software of the present invention until it is determined that the user's gaze has returned to the defined spatial area. In some embodiments a second time threshold value is used such that the user must return his or her gaze to the defined spatial area for more than this second time threshold amount of time for the video stream to resume playing after being paused. This prevents the video to resume playing in response to a fleeting glance from the user. In general this second amount of time is selected long enough such that it will not trigger play upon a fleeting glance, but short enough that a user does not feel like time is being wasted while he or she waits for the video to resume playing. In some embodiments this second threshold amount of time is set to 2 seconds. This threshold is referred to herein as a resume threshold.

In some embodiments of the present invention, the video stream that resumes playing upon a returned glance is not the same moment in time in the video stream at which it was halted. This is because the user has generally looked away some number of seconds before the video stream was halted by the control software. For example in common embodiments the user must look away for 6 seconds before the video was halted, thus the user missed 6 seconds of video content prior to the software automatically pausing the video play. Because a paid advertisement may be short, for example only 30 seconds, missing 6 seconds may be significant. Thus the software of the present invention may be configured such that the video stream, upon resume of play after a look-away, starts from a moment in time in the video stream that is prior to the moment in time when it was halted. This is generally referred to as rewinding the video stream by some amount of time. Thus the software of the present invention may be configured to rewind the video stream by some amount of time, generally an amount equal to or shortly longer than the look-away threshold. In some embodiments the software is configured to rewind the video stream upon a resumed gaze by an amount equal to the look away threshold. This causes the video to resume playing from the last moment in time viewed by the user. In other embodiments the software is configured to add a short amount of time to the look away threshold such that additional viewing context is provided to the user so that he or she gets the full impact of the missed material. For example, in some embodiments two seconds may be added to the look away threshold. This added amount of time is referred to herein as the Added Rewind Time. Thus upon a returned gaze the video is rewinded by an amount equal to the look away threshold plus the added rewind time. The video then resumes playing from that previous point in time.

In some embodiments of the present invention the look away threshold may be determined by the software of the present invention based in whole or in part upon the duration of the advertisement. For example, the software of the present invention may be configured to select and/or derive a shorter look away threshold time for a short duration advertisement than it selects and/or derives for a longer duration advertisement. For example, the software of the present invention may set the look away threshold to be 5 seconds for a video advertisement that is 30 seconds in total duration, but may set the look away threshold to 12 seconds for a video advertisement that is 15 minutes in duration.

In some embodiments of the present invention if the user looks away from the display area during the display of a particular advertisement for more than some maximum look-away threshold amount of time, the software may be configured to rewind the advertisement all the way to the beginning. This is because it may be determined by the software that the interruption was so long, a user could not resume viewing and maintain the mental context for continued viewing in a way that will successfully deliver the advertising message. For example, a maximum look away threshold may be set in some embodiments to 30 minutes. Thus if a user ceases viewing a particular video advertisement (i.e. his or her gaze leaves the defined spatial area) and returns to view that advertisement after 30 minutes of time has elapsed, the control software of the present invention may be configured to rewind the video advertisement to the beginning upon resume of play. Such embodiments generally include steps for tallying the amount of look away time performed by the user. Such tallying can occur a various places within the program flow. For example, step 506 can be adapted to tally the amount of look away time and configured to trigger a flag if and when the amount of look away time has exceeded the maximum look away threshold. If so, the software flow can be routed back to step 500 at which point the video advertisement is started back that beginning or can be route to step 510 and thereby end with no units or other rewards being awarded.

As described with respect to step 509 in FIG. 5, some embodiments of the present invention include an award of exposure units being given to users who view a video based advertisement using the methods and apparatus of the present invention. Thus some aspects of the present invention include the methods, apparatus, and computer programs for awarding exposure units to a user in response to a user successfully viewing the complete duration of a video based advertisement. Other inventive embodiments of the present invention include methods, apparatus, and computer programs for awarding exposure units to a user in response to viewing a portion of the full duration of a video based advertisement, the number of units being awarded being dependent upon the amount and/or percentage of the full duration viewed. These embodiments generally require slightly different program flow processes as compared to that shown in FIG. 5. For example, such embodiments may award some number of exposure units each time a certain amount of time elapses of video display, each time a certain number of frames are displayed during video display, or as certain designated portions of a video based advertisement are successfully delivered to a user over time.

Because the gaze tracking and control software aspects of the present invention are operative to ensure that portions of a video based advertisement are only displayed to a user if and when that user is gazing upon a screen area that is substantially on or near the display area of the video based advertisement, the present invention is an ideal tool for use in awarding units or other compensation or rights in response to viewing part or all of a video based advertisement. As used herein, these credits are referred to as Exposure Units for they represent a value earned by the user in return for being exposed to a certain advertising message.

In some embodiments of the present invention a particular number of Exposure Units to be awarded for a user for viewing a particular video advertisement are determined in partial dependence upon the number of times a user looked away from the defined display area during the viewing of the complete advertisement. This is because a user who looks away many times during the viewing may be considered to have not paid as close attention to a user who looks away fewer times during the viewed advertisement. In some embodiments a running tally of accrued time that a user spent looking away is defined display area is computed by the software of the present invention and used in part to determine the number of Exposure Units to be awarded to the user for viewing the particular video advertisement. The number of times that a user looks away from an advertisement during the viewing duration is referred to herein as the Look-Away Count. The accrued amount of time that a user spent looking away from an advertisement during the viewing duration is referred to herein as the Look-Away Time Talley. Thus the present invention may be configured to use the Look-Away Count and/or the Look-Away Time Talley when computing the number of Exposure Units awarded to a user for viewing a particular advertisement.

In some embodiments of the present invention a user may be awarded Exposure Units for viewing a particular advertisement even if the user chooses not to view the full duration of the advertisement. In such embodiments the number of Exposure Units awarded to the user may be computed by the software of the present invention in partial dependence upon the amount or percentage of the advertisement's full duration that was successfully viewed by the user.

In general, exposure units that are awarded to a user are added by the software of the present invention to an exposure account. The exposure account indicating the number of exposure units earned by the user over a period of time. The exposure units stored in the exposure account are redeemable by the viewer for a certain amount of viewable programming and/or a certain amount of a provided service. For example, the viewer may be awarded a certain number of exposure units for viewing a certain video advertisement in its entirety. The certain number of exposure units are added to the viewers exposure account. The viewer may then use the exposure units to purchase viewable content such as television programming, movies, music, or other published content. In this way the user is gaining access to desirable content in exchange for being exposed to promotional content through a means that allows the promotional content to be experienced independently of the desirable content. Such a system is therefore ideal for content-on-demand delivery systems.

In some embodiments of the present invention the user is shown a running tally of exposure units over time. In some such embodiments the running tally is displayed as a numerical value in a corner (or other unobtrusive area) of the screen upon which the video advertisements are displayed. In some embodiments the running tally is displayed as a graphical chart or table upon the screen (generally in an unobtrusive are). In other embodiments the user may request, using a manual interaction with a user interface or a verbal interaction with a user interface, that a current number of exposure units be displayed or indicated. Regardless of how the running tally is presented to the user, the use of a displayed running tally is a valuable feature. In this way the user has directly feedback of how his viewing of certain durations of the advertisement translates into exposure units earned. An example of such a display is shown in FIG. 6 as element 614. As shown, the user is shown that the current tally within his exposure account is 5220 units.

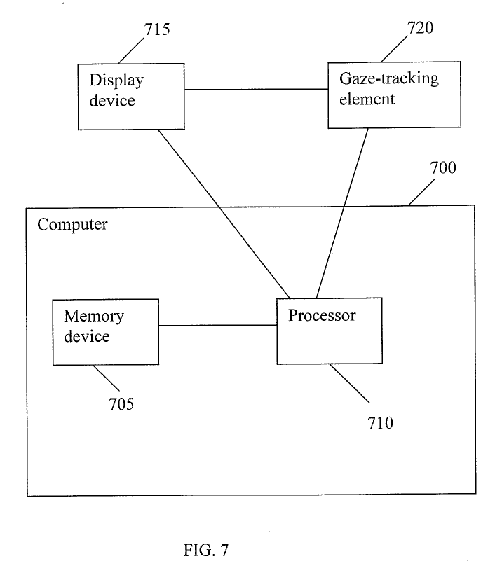

FIG. 7 illustrates a computer 700 according to at least one embodiment of the invention. As shown, the computer 700 includes a memory device 705 and a processor 710. The memory device 705 may include program code to be executed by the processor 710. The processor 710 is also in communication with a display device 715 for displaying media including the video advertisement as described above. A gaze-tracking element 720 is adapted to determined whether the user is looking at the video advertisement.

Some advanced embodiments of the present invention support biometric identification hardware and software known to the art, the biometric identification hardware and software being operative to identify and/or authenticate a particular individual from among a plurality of individuals based upon unique personal features that are detected and processed. For example, gaze tracking systems generally employ hardware and software for capturing images of the users eyes, processes those images, and determining gaze location from the processing. Such systems may be adapted to also perform biometric processing upon the images of the user's eyes to determine a particular user's identify and/or authenticate a particular individual based upon the unique features detected in the images of the user's eyes. The present invention may employ such biometric processing features and thereby identify and/or authenticate a particular user. Other embodiments may employ a camera of the current system to capture images of a portion of the user's face and process that image to determine the identity of that user and/or authenticate that user. Other embodiments may also use additional hardware and software, for example finger print scanning hardware, for determining the identity and/or to authenticate the identity of a particular user.

Biometric-enabled embodiments of the present invention often include a network link to a remote server, the remote server storing biometric identity information for a plurality of users, relationally associating the unique features identified and/or other distilled representation thereof for a particular user with a unique ID or other personal identifier for that user. An example biometric system for user identification is disclosed in U.S. Pat. No. 6,853,739 which is hereby incorporated by reference.

The present invention, when enabled with biometric functionality as described above, may be adapted such that exposure units are only added to the account of a user who is specifically identified and/or authenticated by the biometric hardware and/or software features of the system. For example, if a particular user (i.e., a user identified by a particular ID number such as 2225533) steps up to a display screen and starts viewing a particular advertisement, the biometric features of the present invention identify that user (preferably based upon an analysis of his or her eyes or facial features detected by the gaze tracking hardware tools) and automatically credits that particular user for the viewing of the advertisement. Thus an exposure account associated with and/or the property of user 2225544 is incremented in response to that particular user viewing the video based advertisement. In some embodiments multiple users may view a particular video based advertisement simultaneously. In such embodiments each of the multiple users may be individually identified by the biometric tools of the present invention. For example two particular users may be identified (i.e., user ID 2225533 and user ID 4342245). Thus in response to the two users viewing a particular video based advertisement using the methods of the present invention, the exposure accounts for the two users may be incremented accordingly (i.e., the accounts that are associated with and/or the property of user 2225544 and user 4342245). In this way, the addition of biometric tools and technology may be used to assure that the correct user or users are credited for viewing of an advertising using the gaze responsive methods of the present invention, ensuring that the user who is exposed to the advertising content is the user who is rewarded. This prevents against a user receiving credit for viewing an advertisement who did not actually view it.

The biometric enabled embodiments of the present invention are particularly well adapted to public settings in which a user may view a video based advertisement upon a screen or display that is not his or her personal property and/or is not associated with that user in any way (for example is not his or her work computer). For example, a user waiting for an airplane in a public airport may sit before a screen and/or display and view video based advertisements using the tools of the present invention. The biometric aspects of the present invention may identify the unique identity of that user and thereby credit an account associated with that user for his or her viewing of the video based advertisement. To support such features, the present invention may include a web-based server upon which user exposure accounts are maintained. In this way a computer at a remote location, for example the public airport, can tally an exposure account for the user by sending data to a web-based server that maintains that users exposure account. The user's exposure account may be identified and/or relationally addressed through the unique ID of the user accessed using biometric information for that user. In this way a user may quickly and easily view video based advertisements a variety of locations and have his or her unique exposure account automatically credited for the exposure to those advertisements.

While the invention herein disclosed has been described by means of specific embodiments and applications thereof, numerous modifications and variations could be made thereto by those skilled in the art without departing from the scope of the invention set forth in the claims.

What is claimed is:

1. A method of gaze-responsive video advertising, comprising:
determining whether a user's gaze falls within a predetermined spatial boundary of an advertisement display area;
playing at least a portion of a video-based advertisement within at least a portion of the predetermined spatial boundary in response to an affirmative determining;
stopping the play of the at least a portion of the video-based advertisement in response to determining that the user's gaze falls outside of the predetermined spatial boundary for an amount of time exceeding a predetermined time threshold; and
resuming play of the at least a portion of the video-based advertisement in response to determining that the user's gaze falls within the predetermined spatial boundary of the advertisement display area.

2. The method of claim 1, further comprising rewinding the video-based advertisement by an amount after the stopping and before the resuming play of the video-based advertisement.

3. The method of claim 2, wherein an amount of video rewinded is approximately equal to or greater than the predetermined time threshold.

4. The method of claim 1, further comprising awarding exposure units to the user in response to the user's gaze falling within the predetermined spatial boundary for a predetermined duration increment of the video-based advertisement.

5. The method of claim 4, further comprising displaying a running tally of an amount of the exposure units being awarded to the user in response to the user's gaze falling within the predetermined spatial boundary for the predetermined duration increment of the video-based advertisement.

6. The method of claim 4, wherein the exposure units awarded to the user are redeemable by the user, alone or in combination with other exposure units, for at least one of an amount of viewable programming content and a service provided to the user.

7. The method of claim 4, wherein the exposure units are added to an exposure account that is relationally associated with the user.

8. The method of claim 1, wherein in response to the user's gaze falling outside of the predetermined spatial boundary for more than a second predetermined time threshold, the resuming play of the video-base advertisement occurs at the beginning of the video-based advertisement.

9. The method of claim 1, wherein the advertisement display area is located on at least one of an electronic book and a computer monitor.

10. The method of claim 1, wherein the predetermined spatial boundary comprises a hysteresis band such that a smaller size boundary is used in determining whether the user's gaze falls inside the predetermined spatial boundary and a larger size boundary is used in determining whether the user's gaze falls outside the predetermined spatial boundary.

11. The method of claim 1, wherein the resuming play is performed in response to the determining that the user's gaze falls within the predetermined spatial boundary of the advertisement display area for more than a threshold amount of time.

12. A system for gaze-responsive video advertising, comprising:
a display device including a display region;
a gaze-tracking element to monitor a user's gaze;
a processor to:
determine whether the user's gaze falls within a predetermined spatial boundary of an advertisement display area of the display region,
play at least a portion of a video-based advertisement within at least a portion of the predetermined spatial boundary in response to an affirmative determining,
stop play of the at least a portion of the video-based advertisement in response to determining that the user's gaze falls outside of the predetermined spatial boundary for an amount of time exceeding a predetermined threshold time, and
resume play of the at least a portion of the video-based advertisement after the stopping of play in response to determining that the user's gaze falls within the predetermined spatial boundary of the advertisement display area.

13. The system of claim 12, wherein the processor is adapted to rewind the video-based advertisement by a predetermined amount after the stopping and before the resuming play of the video-based advertisement.

14. The system of claim 12, further comprising an award processor to award exposure units to the user in response to the user's gaze falling within the predetermined spatial boundary for a predetermined duration increment of the video-based advertisement.

15. The system of claim 14, wherein the display is adapted to display a running tally of an amount of exposure units being awarded to the user in response to the user's gaze falling within the predetermined spatial boundary for the predetermined duration increment of the video-based advertisement.

16. The system of claim 12, wherein the processor is adapted to resume play of the video-base advertisement at the beginning of the video-based advertisement in response to the user's gaze falling outside of the predetermined spatial boundary for more than a second predetermined time threshold.

17. The system of claim 12, wherein the display device is located on at least one of an electronic book and a computer monitor.

18. The system of claim 12, wherein the predetermined spatial boundary includes a hysteresis band such that a smaller size boundary is used in determining that the user's gaze falls inside the predetermined spatial boundary and a larger size boundary is used in determining if the user's gaze falls outside the predetermined spatial boundary.

19. A computer-readable medium having encoded thereon computer-readable program code, which when executes causes an electronic device to:
determine whether the user's gaze falls within a predetermined spatial boundary of an advertisement display area of the display region;
play at least a portion of a video-based advertisement within at least a portion of the predetermined spatial boundary in response to an affirmative determining;
stop play of the at least a portion of the video-based advertisement in response to determining that the user's gaze falls outside of the predetermined spatial boundary for an amount of time exceeding a predetermined threshold time; and
resume play of the at least a portion of the video-based advertisement after the stopping of play in response to determining that the user's gaze falls within the predetermined spatial boundary of the advertisement display area.

20. The computer-readable medium of claim 19, wherein the computer-readable program code when executed further causes the computer to rewind the video-based advertisement by a predetermined amount after the stopping of play and before the resuming of the play of the video-based advertisement.

21. The computer-readable medium of claim 19, wherein the computer-readable program code when executed further causes the computer to award exposure units to the user in response to the user's gaze falling within the predetermined spatial boundary for a predetermined duration increment of the video-based advertisement.

22. The computer-readable medium of claim 19, wherein the computer-readable program code when executed further causes the computer to display a running tally of an amount of the exposure units being awarded to the user in response to the user's gaze falling within the predetermined spatial boundary for predetermined duration increments of the video-based advertisement.

23. The computer-readable medium of claim 19, wherein the computer-readable program code when executed further causes the computer to resume play of the video-base advertisement occurs at the beginning of the video-based advertisement in response to the user's gaze falling outside of the predetermined spatial boundary for more than a second predetermined time threshold.

24. The computer-readable medium of claim 19, wherein the computer-readable program code when executed causes the predetermined spatial boundary to include a hysteresis band such that a smaller size boundary is used in determining that the user's gaze falls inside the predetermined spatial boundary and a larger size boundary is used in determining if the user's gaze falls outside the predetermined spatial boundary.
